(19) United States
(12) Patent Application Publication
(10) Pub. No.: US 2007/0156631 A1
(43) Pub. Date: Jul. 5, 2007

(54) Synchronization of transactional applications and analytical applications

(75) Inventor: Ilja Fischer, Bad Schoenborn (DE)

Correspondence Address: KENYON & KENYON LLP, 1500 K STREET N.W., WASHINGTON, DC, 20005, US

(73) Assignee: SAP AG

(21) Appl. No.: 11/319,439

(22) Filed: Dec. 29, 2005

(51) Int. Cl. G06F 17/30

(52) U.S. Cl. 707/1

(57) ABSTRACT

Systems and methods are provided to synchronize transactional applications and analytical applications. When a user modifies data stored in a backend system via a transactional application, the transactional application may send a portal event to an analytical application. If an analytical application receives such a portal event, it may select data from the backend system in order to display information based on data that may have been changed by the user. Communication between the analytical application and the backend system may be reduced. Furthermore, the analytical application may have more reliable access to up-to-date data, making it more likely that the information displayed to the user is correct and current.

### BACKGROUND

In complex systems such as enterprise management systems, a user may access transactional applications and analytical applications simultaneously. These applications may be accessed via a portal that shows views created by the various applications. Transactional applications support the transactions performed by the enterprise. For example, transactional applications allow users to perform tasks such as creating a purchase order, entering a new customer, placing a supply order, and other tasks. Analytical applications generally analyze and display information created from stored data to measure performance within the enterprise. For example, an analytical application may provide information on the number of debtors and creditors of the enterprise, the efficiency of various shipping methods, the percentage of accounts overdue, and other information. When a user performs a task using a transactional application, a related analytical application continues displaying information based on data as it existed prior to the user's actions. In order to display information based on updated, created, or deleted data, an analytical application must re-select data including the modified data from the backend system.

Such a system is shown in FIG. 1. A user 101 invokes a portal 110 to display interfaces 131 and 132 to a transactional application 111 and an analytical application 112. The portal 110 may provide a graphical user interface to allow access to data and other information, such as a web browser or other executable program. When a user causes data stored in the backend system 120 to be modified via the transactional application 111, the transactional application updates, creates, or deletes data stored in the backend system 120. In order to display information based on this updated data, the analytical application interface 132 must request updated data from the backend system 120. Continual or regular selection of the data may unnecessarily consume system resources. However, if the analytical application interface does not receive updated data, it will display incorrect or obsolete information. Thus, there is a need for a method and system allowing an analytical application to select data after the data is modified via a transactional application, without requiring regular or continual selections.

### BRIEF DESCRIPTION OF THE DRAWINGS

FIG. 1 shows a system having a transactional application and an analytical application accessed via a portal.

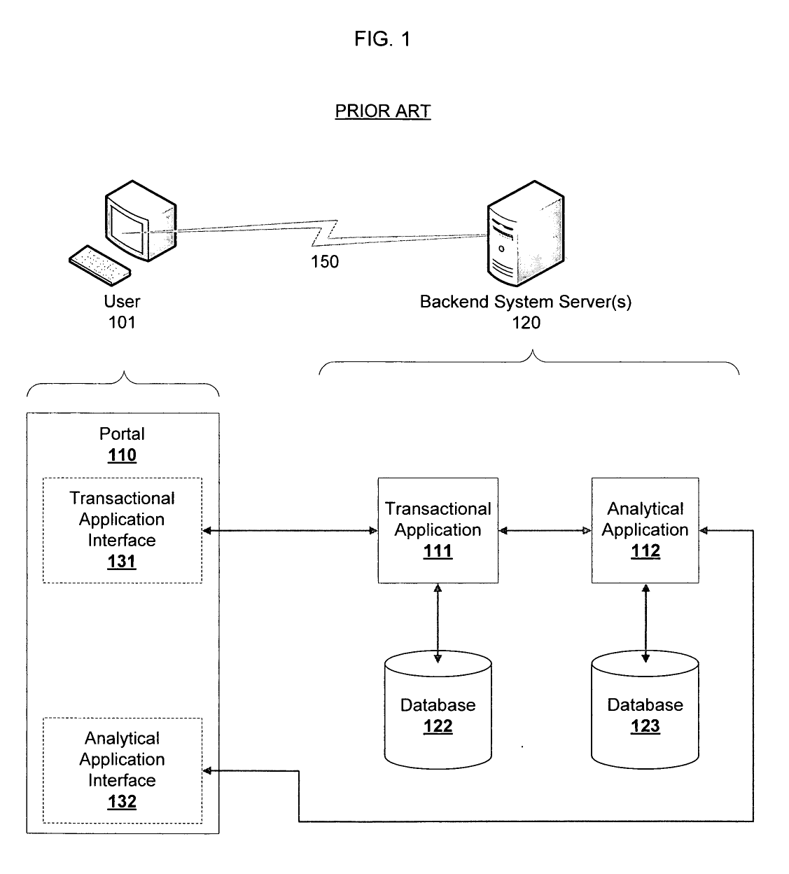

FIG. 2 shows a system having a transactional application and an analytical application accessed via a portal according to an embodiment of the invention.

FIG. 3 shows a system having a transactional application and an analytical application according to an embodiment of the invention.

FIG. 4 shows a block diagram illustrating communications among a user, a portal, a transactional application, an analytical application, and a backend system according to an embodiment of the invention.

FIG. 5 shows a process for modifying data according to an embodiment of the invention.

### DETAILED DESCRIPTION

The present invention provides systems and methods to synchronize a transactional application and an analytical application. When a user modifies data stored in a backend system via a transactional application, the transactional application may send a portal event to an analytical application. If an analytical application receives such a portal event, it may select data from the backend system in order to display information based on data that may have been changed by the user. The portal event may include information describing changes made by the user. The analytical application may not update the data it displays or on which it bases displayed information in the absence of a portal event. Thus, communication between the analytical application and the backend system may be reduced. Furthermore, the analytical application may have more reliable access to up-to-date data, making it more likely that the information displayed to the user is correct and current.

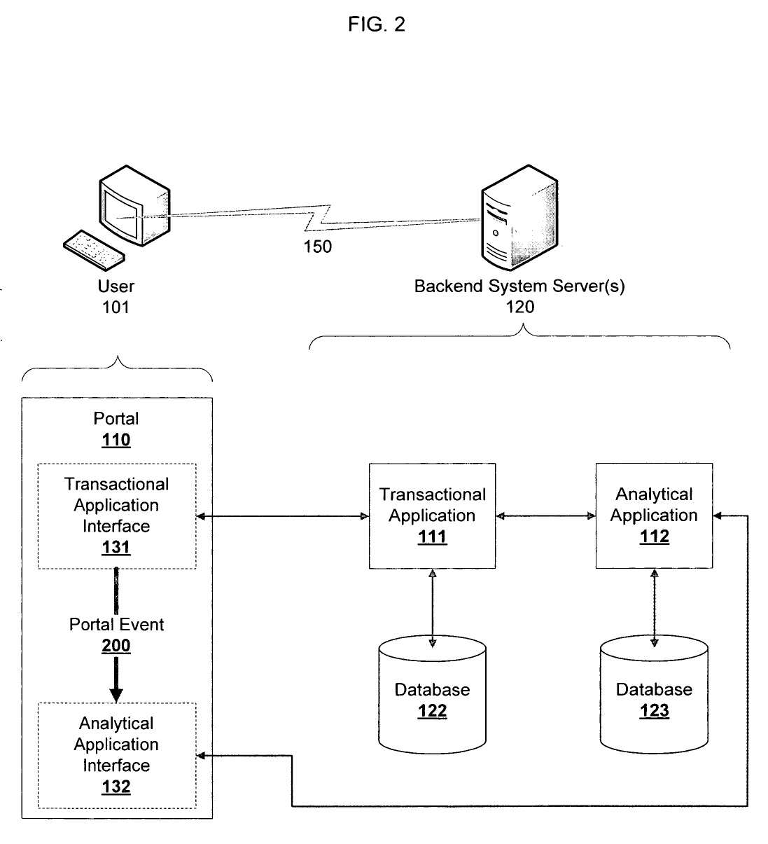

FIG. 2 shows a system for accessing data according to embodiments of the present invention. A user 101 may access a backend system 120 via a portal 110. The backend system may contain one or more servers and applications 111, 112. The user terminal 101 and the backend system 120 may be connected via a communication network 150. The topology, architecture, and related protocols are immaterial to the present invention unless otherwise specified herein. Each server 120 may store and execute one or more applications. The system 120 may also contain one or more databases 122 and 123, where each application may have access to one or more of the databases. In some embodiments, each application may be associated with a database to store data associated with the application. Various other arrangements of servers, databases, and applications are possible. The specific number and arrangement of servers, databases, and topologies is immaterial to the present invention unless otherwise specified. An application may present information to a user by transmitting information to an application interface. Similarly, a user may perform a task, view data and otherwise interact with an application by performing operations in an application interface, which then transmits commands to an application.

For example, the portal 110 may be a web browser that displays a transactional application interface 131 and an analytical application interface 132 in separate frames. Each application interface 131 and 132 allows a user to interact with an application 111 and 112, respectively. The portal 110 may invoke the transactional application interface 131 and the analytical application interface 132, such as by loading a set of navigation elements, command elements and other interfaces. The analytical application interface 132 may present information based on the data or type of data that the transactional application interface 131 allows a user to view and modify. As a specific example, the transactional application 111 may allow a user to view, create, delete, and modify vendor contracts, and the analytical application 112 may calculate and present the total number of current contracts, contracts created in the recent month, or other information derived from or related to information accessible via the transactional application 111. The analytical application may display other data stored in the system and other information derived from that data. For example, the analytical application may request a list of all current contracts from a database 122. It may then calculate performance measurements, summary information, or other information from the data received. Examples of such information include the number of contracts ending over the next six months, the total value of all current contracts, and the expected average profit from each contract. Other types of information may be calculated and displayed. The analytical application 112 may store derived information in a database 122 or 123, for use later. When the analytical application receives a request for information from the analytical application interface 132, it may display previously-stored information or it may compile information to display at the time the request is received. In general, an analytical application may display both data that is drawn directly from the backend system, and information that is calculated, derived from, or otherwise based on that data.

A user may access the transactional application to initiate transactions in the system, which may result in modifications to data stored in the backend system. After such a modification is complete, the database in which the changed data is stored 122 may send a message or other indication to the transactional application 111 that the data has been successfully modified. The transactional application interface 131 may indicate to the user that a change has been made to data stored in the system 120 and/or send a portal event 200 to the analytical application interface 132. The portal event 200 may contain information about the modification, such as the type of data modified or an identifier associated with the updated data. For example, if user initiates a transaction that adds a row to a database table, the portal event 200 may contain a unique identifier associated with the new entry or the name of the table that was modified. Similarly, the portal event 200 may contain general information indicating that data has been modified. When an analytical application interface 132 receives a portal event 200, it may request data from the backend system 200. For example, it may request updated analytical data stored by the analytical application 112 in an associated database 123. If the portal event 200 specifies specific data or data structures that were modified by a transaction, the analytical application 132 may request only the data that was modified, or it may request additional data.

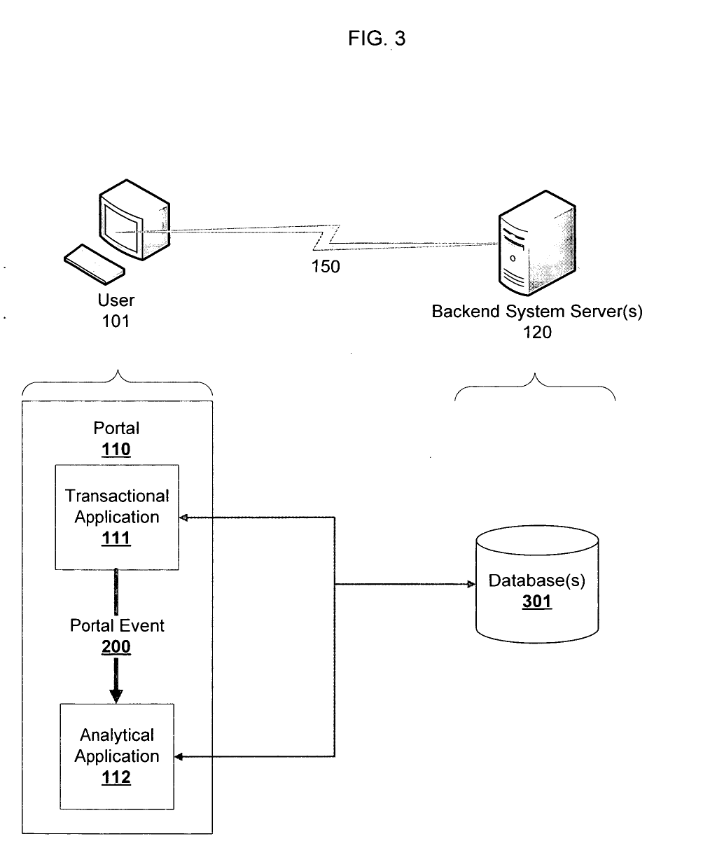

The applications 111 and 112 may execute on remote servers as previously described, or they may be stored and execute on the user's client computer. Such an embodiment of the invention is shown in FIG. 3. A user may access a transactional application 111 and an analytical application 112 via a portal 110. The applications and/or portal may be stored and executed on the user client 101. For example, the portal 110 may be a web browser, a windowed operating system, or other appropriate program. The applications may be displayed in frames within a web browser, as windows within an executable program running on the client computer, as separate windowed programs running within a windowed operating system, or any other appropriate arrangement. Each of the applications may have access to one or more databases 301 contained in the backend system 120. When a user initiates a transaction via the transactional application 111, the transactional application may alter data 301 stored in the backend system. It may then send a portal event to the analytical application 112 as previously described. The analytical system may request data from the backend system, for example by querying one or more databases 301. As previously described, the analytical system may then display updated information that is derived from data altered by the transactional application.

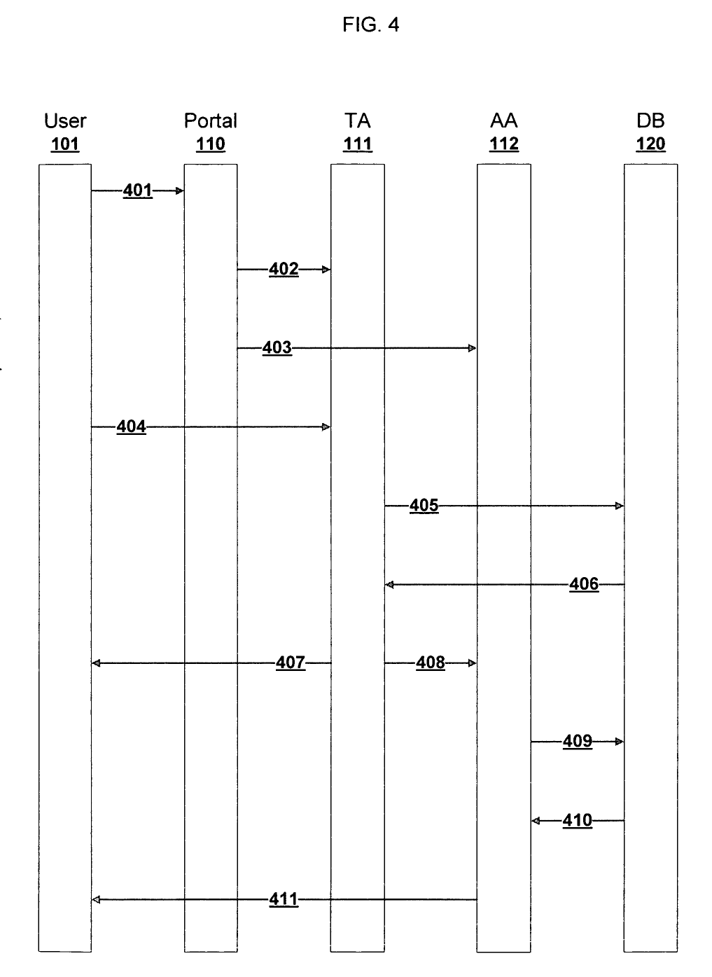

An example of communications between components in embodiments of the present invention, such as the system described with respect to FIGS. 2 and 3, is illustrated in FIG. 4. A user 101 may invoke (401) a portal 110 to display interfaces to a transactional application 111 and an analytical application 112. The portal may then invoke the applications (402 and 403 respectively) or application interfaces as described with respect to FIG. 2. In some embodiments, the user may invoke the applications, for example by selecting them from a menu or other navigation tool in the portal. A user may then send input (404) to the transactional application 111 in order to modify data stored in the backend system 120. After receiving a command or other input (404) from a user, the transactional application may send a command (405) to the backend system with instructions to modify stored data. If the stored data is successfully modified, a response (406) may be sent to the transactional application. The transactional application may also display information to the user (407) indicating that the modification is complete. If the transaction was not processed successfully, the response (406) and user notification (407) may indicate that an error occurred. If the transaction is successfully processed, the transactional application may also send a portal event (408) to the analytical application. The portal event may contain information related to the update as previously described. When the analytical application receives such a portal event, it may request (409) and receive (410) data from the backend system, and subsequently display updated information (411) to the user.

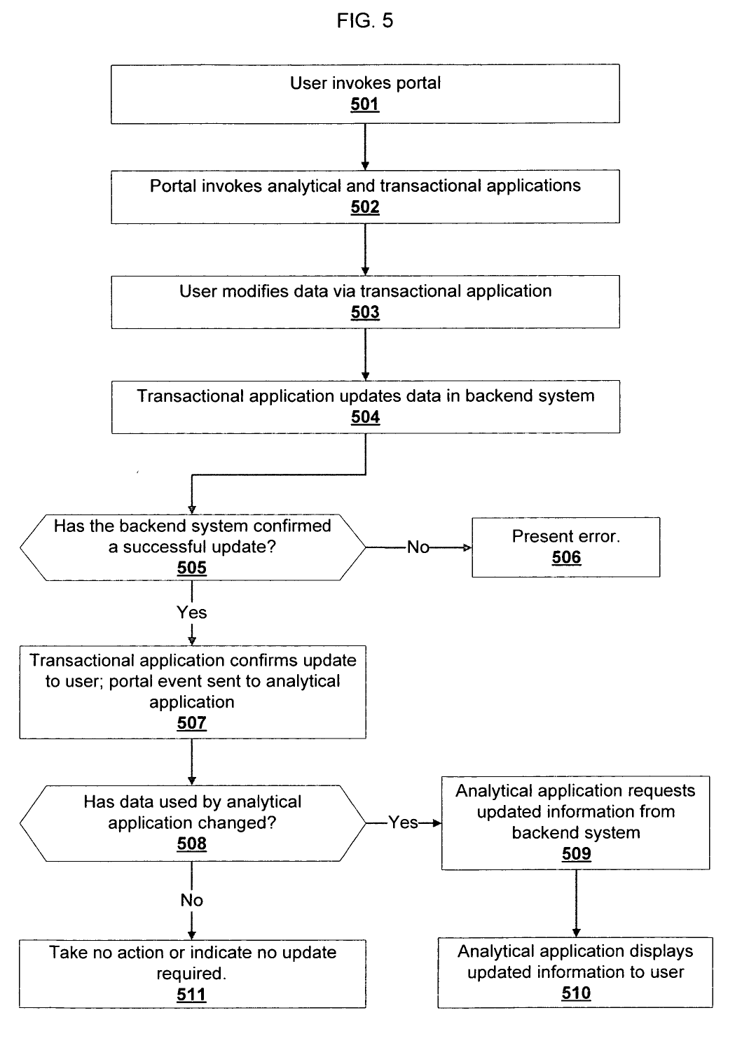

FIG. 5 illustrates an example process according to embodiments of the present invention. As previously described, a user may invoke a portal 501 to display and provide access to a transactional application and an analytical application. The portal may invoke the applications 502, or the applications may be invoked by a user. When a user performs an operation via the transactional application 503, the transactional application may update data stored in a backend system 504. For example, a user may change the address of a business partner in a transactional application displaying and providing access to business partner information. If the backend system confirms that the update initiated by the user is successful 505, the transactional application may confirm the update to the user and send a portal event to the analytical application 507. If the update does not complete successfully, an error may be presented 506 to the user.

When the analytical application receives a portal event 508, it may determine if a request is required to update the information displayed in the analytical application. For example, if the user updated a business partner address as described above, the portal event may contain information describing this update. If the analytical application is displaying information derived from, for example, the number of contracts with each business partner, it may not need to request updated data from the backend system in response to the update of a business partner address. Similarly, if the analytical application displays information describing the geographic distribution of business partners, the information may be inaccurate after the update is complete. In such a case where the analytical application displays information that may be rendered inaccurate by a user modification of data, the analytical application may request the updated data from the backend system 509. If the portal event does not contain information specifying details about the data that was updated, the analytical application may request updated information from the backend server after each portal event received by the transactional application.

If the analytical application determines that it does not need to request updated data, it may display an indication 511 that the information displayed by the analytical application was unchanged by the update performed by the user. If the analytical application requests data from the backend server, it may then update displayed information that contains or is derived from the data and display the updated information to the user 510.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method of synchronizing a transactional application and an analytical application, comprising:
in response to a user command performed in a transactional application, updating data stored in a backend system;
notifying the transactional application that the update is complete;
sending a portal event to an analytical application;
in response to an analytical application receiving a portal event, selecting data from the backend system; and
displaying information derived from the selected data in the analytical application.

2. The method of claim 1 wherein the transactional application and the analytical application are displayed in a portal.

3. The method of claim 1 wherein the portal event contains information describing the command performed by the user.

4. A method of synchronizing a transactional application and an analytical application, comprising:
in response to a user command performed in a transactional application, updating data stored in a backend system;
notifying the transactional application that the update is complete;
sending a portal event to an analytical application interface;
in response to an analytical application interface receiving a portal event, selecting data from the backend system; and
displaying information derived from the selected date in the analytical application interface.

5. The method of claim 4 wherein a transactional application interface and the analytical application interface are displayed in a portal.

6. The method of claim 4 wherein the portal event contains information describing the command performed by the user.

7. A method of maintaining data and information consistency, comprising:
in response to a change to data stored in a backend system by a transactional application, determining if the change was made successfully;
if the change was made successfully, sending a portal event to an analytical application, otherwise displaying an error;
in response to a portal event, determining if information displayed in an analytical application is derived from the changed data;
if the displayed information is derived from the changed data, requesting the changed data from the backend system;
updating the displayed information to reflect the change to the data; and
displaying the updated information in the analytical application.

8. A system comprising:
a portal for displaying a transactional application interface and an analytical application interface; and
a backend system for storing data;
wherein the transactional application interface sends a portal event to the analytical application interface after a successful update to data stored in the backend system.

9. The system of claim 8 further comprising a transactional application and an analytical application, wherein the transactional application and the analytical application run on one or more servers, and information is transmitted to the transactional application interface and the analytical application interface across a computer network.

10. A machine-readable medium containing program instructions for execution on at least one processor, which when executed by the processor cause the processor to perform:
in response to a user command performed in a transactional application, updating data stored in a backend system;
notifying the transactional application that the update is complete;
sending a portal event to an analytical application interface;
in response to an analytical application receiving a portal event, selecting data from the backend system; and
displaying information derived from the selected data in the analytical application interface.

11. The machine-readable medium of claim 10, further comprising displaying the transactional application and the analytical application in a portal.

12. The machine-readable medium of claim 10, wherein the portal event contains information describing the command performed in the transactional application.

13. A machine-readable medium containing program instructions for execution on at least one processor, which when executed by the processor cause the processor to perform:
in response to a user command performed in a transactional application, updating data stored in a backend system;
notifying the transactional application that the update is complete;
sending a portal event to an analytical application interface;
in response to an analytical application receiving a portal event, selecting data from the backend system; and
displaying information derived from the selected data in the analytical application.
